(19) United States
(12) Patent Application Publication
(10) Pub. No.: US 2004/0208500 A1
(43) Pub. Date: Oct. 21, 2004

(54) Print service support system

(75) Inventors: Tetsuya Kiyosu, Tokyo (JP); Satoshi Suzuki, Tokyo (JP); Katsumi Kanazawa, Tokyo (JP); Takeshi Morimoto, Tokyo (JP); Takahide Inoue, Tokyo (JP); Kenichiro Kigo, Kanagawa (JP); Rumiko Kakehi, Kanagawa (JP); Shunichi Kojima, Kanagawa (JP); Shoichi Goto, Tokyo (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/822,756

(22) Filed: Apr. 13, 2004

(30) Foreign Application Priority Data
Apr. 15, 2003 (JP) 2003-110906
Sep. 16, 2003 (JP) 2003-323661
Sep. 16, 2003 (JP) 2003-323662

(51) Int. Cl. G06F 17/60; G03B 41/00; B41B 15/00

(52) U.S. Cl. 396/549; 705/40; 396/310

(57) ABSTRACT

A print service support system for supporting print service for producing prints related to data while delivering the data among a plurality of agencies including a unit for accepting information for specifying the plurality of agencies, a unit for generating project information as information for specifying agencies to carry out a project to specify the plurality of agencies and remarkable machine information for specifying a given remarkable print output machine, a selection unit for selecting at least one piece of the information for specifying the agencies, which information is included in the generated project information, a unit for generating device link profile information for the agency including information for simulating color reproducibility of the remarkable print output machine using a print output machine, and information for specifying the agency, and a storage unit for storing the generated device link profile information. Preferably, the device link profile information is used for delivering data from one of the agencies to another.

### BACKGROUND OF THE INVENTION

1. Field of the Invention

The present invention relates to a system for supporting print service taken part in by a plurality of agencies.

2. Background Art

In a general flow, advertising prints used in newspaper, magazine, direct mail or the like are commissioned from a client of the advertisement (that is, advertiser) to an advertising company, and the advertising company serves as a manager using a large number of agencies for producing the prints. For example, in the case of a magazine advertisement, the advertising company selects agencies including an advertising production company for producing the advertisement actually, a publisher of the magazine, a prepress company, and a printing company. Then, the publisher receives and adjusts data of the advertisement produced by the advertising production company. The prepress company performs prepress based on the adjusted data. The printing company prints the prepress data, binds obtained prints and submits the bound prints to delivery agencies.

In recent years, so-called DTP (Desk Top Publishing) for manufacturing prints using a computer has been popular. Data delivered from one agency to another is often computer data. Therefore, each agency can display the data on its own computer, print the data using its own print output machine, and adjust the tint or the like.

However, the color reproducibility of one print output machine is not always identical to that of another. That is, to take data of four colors C, M, Y and K as an example, the current situation is that there is a slight difference between the color outputted from one print output machine and that from another in spite of the same values of C, M, Y and K. As a result, when only the data is delivered, the printing company may not always print the advertising prints in the same color as the color produced in the production company. That is, each agency must refer to results printed actually by print output machines of other agencies as samples.

Incidentally, there is a system for achieving matching in color reproducibility among print output machines as disclosed in JP-A-2002-290756.

### SUMMARY OF THE INVENTION

Although printing has been heretofore performed using a computer thus, a method for delivering only data has not been adopted in the field of commercial printing, but it has been necessary to deliver a result of printing on a paper medium. On the other hand, in the field of commercial printing, there has been a strong demand to shorten the taken time from the production of data to the completion of prints. Thus, a system capable of managing with only delivery of data has been demanded.

In addition, when a printing office accepts data before rasterization, which data was produced in another agency, such as PDF, as it is, it may be preferable that RIP (Raster Image Process) such as rasterization is performed on the data in the printing office.

The invention was developed in consideration of the foregoing situation. It is an object of the invention to provide a print service support system which can make color reproducibility in one agency coincide with that in another agency while the system can manage with only delivery of data.

It is another object of the invention to provide a print service support system which can make color reproducibility in one agency coincide with that in another agency while the system can manage with only delivery of data, and in which data suitable for delivery of data before rasterization can be delivered to an agency to print the data.

It is another object of the invention to provide a system for totally supporting print service in which a large number of agencies cooperate with one another to produce prints.

In order to solve the foregoing problems in the background art, according to the invention, there is provided a print service support system for supporting print service for producing prints related to data while delivering the data among a plurality of agencies, including: a unit for accepting information for specifying the plurality of agencies; a unit for generating project information as information for specifying agencies to carry out a project, the project information including at least a part of the information for specifying the plurality of agencies and remarkable machine information for specifying a given remarkable print output machine of print output machines which are available in the project to be carried out; a selection unit for selecting at least one piece of the information for specifying the agencies, which information is included in the generated project information; a unit for generating device link profile information for each agency specified by the information selected by the selection unit, the device link profile information including information for achieving matching in color reproducibility between the remarkable print output machine and a print output machine to be used by the agency, and information for specifying the agency; and a storage unit for storing the generated device link profile information; wherein the device link profile information is used for delivering data from one of the agencies to another.

Further, in order to solve the foregoing problems in the background art, according to the invention, there is provided a print service support method for supporting print service for producing prints related to the data while delivering data from one of a plurality of agencies to another, including the steps of: generating project information as information for specifying agencies to carry out a project, the project information including at least a part of information for specifying the plurality of agencies and remarkable machine information for specifying a given remarkable print output machine of print output machines which are available in the project to be carried out; selecting at least one piece of the information for specifying the agencies, which information is included in the generated project information; generating device link profile information for each agency specified by the information selected in the selecting step, the device link profile information including information for simulating color reproducibility of the remarkable print output machine using a print output machine to be used by the agency, and information for specifying the agency; and storing the generated device link profile information; wherein the steps are executed by a computer system and wherein the device link profile information is used for delivering data from one of the agencies to another.

In addition, in order to solve the foregoing problems in the background art, according to the invention, there is provided a print service support program for supporting print service for producing prints related to data while delivering the data among a plurality of agencies, including the steps of: generating project information as information for specifying agencies to carry out a project, the project information including at least a part of information for specifying the plurality of agencies and remarkable machine information for specifying, of print output machines available in the project to be carried out, a given remarkable print output machine; selecting at least one piece of the information for specifying the agencies, which information is included in the generated project information; generating device link profile information for each agency specified by the information selected in the selecting step, the device link profile information including information for simulating color reproducibility of the remarkable print output machine using a print output machine to be used by the agency, and information for specifying the agency; and storing the generated device link profile information in a storage unit; wherein the steps are executed by a computer system; and wherein the device link profile information is used for delivering data from one of the agencies to another.

In order to solve the foregoing problems in the background art, according to the invention, there is provided a print service support system including: a data acceptance server group, a data processing server group and a data delivery server group, each group including at least one server unit; and a database generated in advance based on profile information about a device to be used by each agency, the database retaining predetermined processing parameters for data to be delivered from an agency which will be a delivery source of the data to an agency which will be a delivery destination of the data; wherein as to data related to print service accepted from a delivery source by one server unit of the data acceptance server group, one server unit of the data processing server group acquires, from the database, the predetermined processing parameters between an agency which will be a delivery destination of the data and an agency which will perform final output of the data, and processes the data based on the acquired predetermined processing parameters; and wherein one server unit of the data delivery server group distributes the processed data to the agency which will be a delivery destination of the data. The number of server units belonging to each of the data acceptance server group, the data processing server group and the data delivery server group may be determined in accordance with a load on the server units in each of the server groups.

In addition, in order to solve the foregoing problems in the background art, according to the invention, there is provided a print service support method using a data acceptance server group, a data processing server group and a data delivery server group, each group including at least one server unit, and a database generated in advance based on profile information about a device to be used by each agency, the database retaining predetermined processing parameters for data to be delivered from an agency which will be a delivery destination of the data to an agency which will perform final output of the data, the method including the steps of: allowing one server unit of the data processing server group to acquire data related to print service accepted from a delivery source by one server unit of the data acceptance server group; allowing the server unit acquiring the data to acquire, from the database, the predetermined processing parameters between an agency which is a delivery source of the data and an agency which will be a delivery destination of the data, and processes the data based on the acquired predetermined processing parameters; and allowing one server unit of the data delivery server group to distribute the processed data to the agency which will be a delivery destination of the data.

In order to solve the foregoing problems in the background art, according to the invention, there is provided a print service support system for supporting print service for producing prints related to data while delivering the data among a plurality of agencies, including: a data acceptance server group, a preprocessing server group, a data processing server group and a data delivery server group, each group including at least one server unit; a unit for accepting information for specifying the plurality of agencies; a unit for generating project information as information for specifying agencies to carry out a project, the project information including at least a part of the information for specifying the plurality of agencies and remarkable machine information for specifying, of print output machines available in the project to be carried out, a given remarkable print output machine; and a unit for generating predetermined processing parameters as to a print output machine to be used by each agency and the remarkable print output machine, and retaining the predetermined processing parameters in a database; wherein a server unit belonging to the preprocessing server group judges whether data related to print service accepted from a delivery source by one server unit of the data acceptance server group satisfies a predetermined providing condition or not, and when the server unit concludes that the data does not satisfy the providing condition, one server unit of the data processing server group acquires, from the database, the predetermined processing parameters as to a print output machine to be used by an agency which will be a delivery destination of the data and the remarkable print output machine, and processes the data based on the acquired predetermined processing parameters, whereupon one server unit of the data delivery server group distributes the processed data to the agency which will be a delivery destination of the data; and wherein when the server unit of the preprocessing server group concludes that the data related to print service and accepted from the delivery source satisfies the providing condition, the data is distributed directly to the agency which will be a delivery destination.

In addition, in order to solve the foregoing problems in the background art, according to the invention, there is provided a print service support method for supporting print service for producing prints related to data while delivering the data among a plurality of agencies, using a data acceptance server group, a preprocessing server group, a data processing server group and a data delivery server group, each group including at least one server unit, the method including the steps of: allowing one of the server groups to accept information for specifying the plurality of agencies; allowing one of the server groups to generate project information as information for specifying agencies to carry out a project, the project information including at least a part of the information for specifying the plurality of agencies and remarkable machine information for specifying, of print output machines available in the project to be carried out, a given remarkable print output machine; allowing one of the server groups to generate predetermined processing parameters as to a print output machine to be used by each agency and the remarkable print output machine, and retain the predetermined processing parameters in a database; and allowing a server unit belonging to the preprocessing server group to judge whether data related to print service accepted from a delivery source by one server unit of the data acceptance server group satisfies a predetermined providing condition or not; wherein when the server unit concludes that the data does not satisfy the providing condition, one server unit of the data processing server group acquires, from the database, the predetermined processing parameters as to a print output machine to be used by an agency which will be a delivery destination of the data and the remarkable print output machine, and processes the data based on the acquired predetermined processing parameters, whereupon one server unit of the data delivery server group distributes the processed data to the agency which will be a delivery destination of the data; and wherein when the server unit belonging to the preprocessing server group concludes that the data satisfies the providing condition, the data related to the print service and accepted from the delivery source is distributed directly to the agency which will be a delivery destination.

### BRIEF DESCRIPTION OF THE DRAWINGS

The present invention may be more readily described with reference to the accompanying drawings:

FIG. 1 is a block diagram showing the configuration of a print service support system according to a first embodiment of the invention, and its connecting conditions;

FIG. 2 is an explanatory diagram showing the contents of a user database by way of example;

FIG. 3 is an explanatory diagram showing the contents of a project database by way of example;

FIG. 4 is a flowchart showing an example of a data delivery process;

FIG. 5 is a block diagrams showing the configuration of a print service support system according to a second embodiment of the invention, and its connecting conditions;

FIG. 6 is a flow chart showing an example of a data acceptance process; and

FIG. 7 is a block diagrams showing the configuration of a print service support system according to a third embodiment of the invention, and its connecting conditions.

### DETAILED DESCRIPTION OF THE PREFERRED EMBODIMENTS

[First Embodiment]

Embodiments of the invention will be described with reference to the drawings. A print service support system according to each embodiment of the invention sets a print output machine for producing prints actually as a remarkable print output machine by way of example, and simulates the color reproducibility of the remarkable print output machine using a print output machine available in each agency taking part in the production of the prints. Thus, the print service support system can manage with only delivery of data while achieving matching in color reproducibility among the agencies.

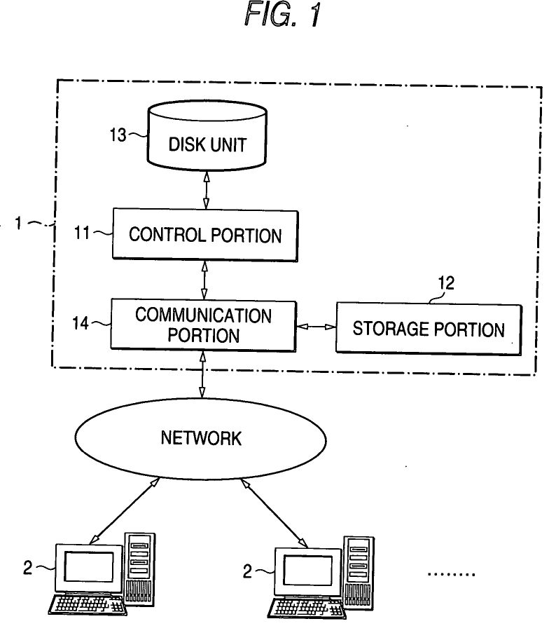

A system 10 according to a first embodiment of the invention is constituted specifically as shown in FIG. 1. That is, the system 10 is connected to personal computer systems PC disposed in agencies taking part in producing prints, through a network. The system 10 includes a control portion 11, a storage portion 12, a disk unit 13 and a communication portion 14.

Description will be made below on the assumption that an advertising agency or the like receiving a request from a client to produce prints becomes a project manager for managing agencies engaged in services such as design, publication and the like. That is, for each item requested from a client, an agency serving as a project manager sets up a team of agencies and manages the performance of print service. In the following description, assume that each item is managed as “project”.

The control portion 11 operates in accordance with a program stored in the disk unit 13, fundamentally executing a process for accepting registration of agencies or registration of projects, a process for making a plurality of agencies in each project share data with one another, a process for delivering the data, a process for managing a work flow for each project, a process for managing a production history, and a process for generating and providing information for simulating the properties of a printing result in a remarkable print output machine, such as color reproducibility in a print output machine available in each agency. Specific contents of these processes will be described in detail later.

The storage portion 12 operates as a work memory of the control portion 11. The disk unit 13 stores programs to be executed by the control portion 11. Here, the programs to be executed by the control portion 11 are, for example, modularized for each of the processes. In addition, the disk unit 13 also operates as a storage for storing information generated by the control portion 11. The communication portion 14 transmits various kinds of data through the network in accordance with an instruction inputted from the control portion 11, and outputs data received through the network to the control portion 11.

Next, description will be described on each process to be executed by the control portion 11. The control portion 11 operates as a web server, communicating with each personal computer systems PC using a protocol such as HTTP.

[Agency Registration Process]

Information of each agency using the system according to the first embodiment is registered in advance in the following process. That is, when accessed by a personal computer system PC of an agency wanting to register itself, the control portion 11 starts up the module for the agency registration process stored in the storage portion 12 so as to provide a web page for user registration and allow the agency to input and submit general information such as an agency name and a contact address as well as authentication information such as a registration user name and a password.

In addition, the control portion 11 provides a device registration screen for accepting an input of information for specifying a print output machine the user can use. Here, for example, the maker name, device name and the like of the print output machine are inputted. When a plurality of pieces of information for specifying print output machines are received from the agency, the control portion 11 makes the user designate one of the plural print output machines as a so-called default print output machine the user uses mainly.

The control portion 11 issues an identifier (user ID) proper to the user and an identifier (device ID) proper to each print output machine, and gives notification of the user ID and the device ID to the user as the access source.

Then, the control portion 11 distributes color-measuring patch data stored in advance in the disk unit 13 to the personal computer system PC of the access source in accordance with a protocol such as HTTP or FTP.

On the agency side, the distributed color-measuring patch data is printed on predetermined paper using each print output machine registered here, and the printing result of the color-measuring patch data in the print output machine is associated with the device ID assigned to the print output machine, and delivered to a not-shown color-measuring center together with the device ID. This delivery is performed not electronically but by mail or the like. In the color-measuring center, color-measuring is performed based on the printing result, and data of the color-measuring result (color-measuring result data) is associated with the device ID associated with the printing result, and transmitted to the print service support system 101 together with the device ID.

The control portion 11 receives the color-measuring result data and the device ID associated therewith. The control portion 11 associates the device ID and the color-measuring result data with each other and stores them in the disk unit 13.

Here, the color-measuring result data is obtained as follows. That is, a color signal (machine-dependent color signal) such as CMYK or RGB as color-measuring patch data dependent on each machine is provided to a print output machine to be measured. In the print output machine, a color-measuring result as to the color of an image printed based on the color signal is obtained. The color-measuring result is generally a color signal (machine-independent color signal) obtained independently of the print output machine, such as Lab, L*u*v or XYZ. Incidentally, color expression using CMYK, RGB, Lab, L*u*v or XYZ is known broadly, and description thereof will be omitted.

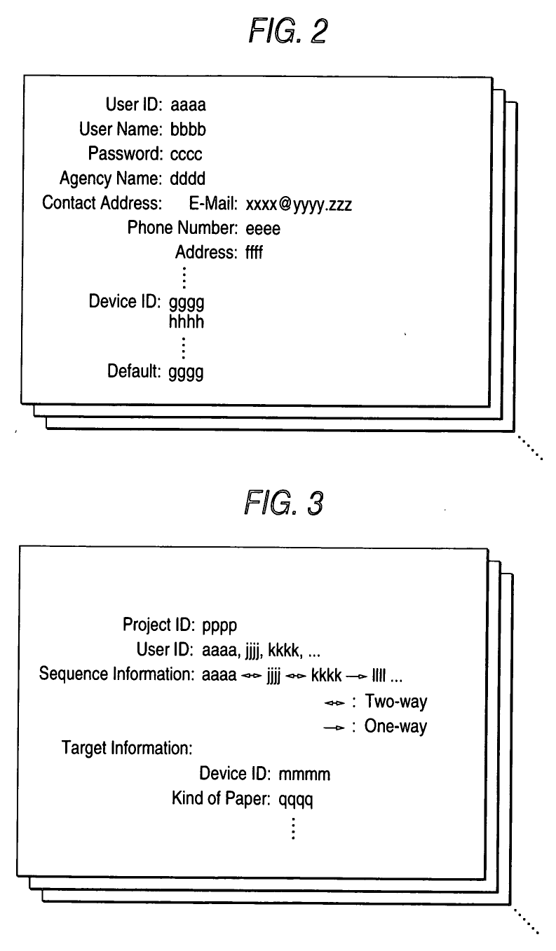

As a user database obtained as a result of the registration process, as shown in FIG. 2, the authentication information such as a user name and a password, the general information, and the information for specifying one or more registered device IDs and one of the device IDs designated as default are stored in the disk unit 13 so as to be associated with one another using the user ID as a key. In addition, for each device ID, the color-measuring result data received in association with the device ID is stored as a device database in the disk unit 13.

Incidentally, in this embodiment, registration is done for each user, and all the users using this system in each agency are registered on an individual basis. However, registration may be done based on an agency name representing each agency.

[Project Registration Process]

In addition, in the system according to the first embodiment, the agency as a project manager accepting a request from a client selects other agencies to be engaged in producing the requested prints, and registers information for specifying each selected agency as well as information for specifying the project manager itself. That is, the agency as the project manager acquires, from each selected agency, user IDs associated with users in the agency in advance. Then, the project manager makes a request to the print service support system 101 for project registration.

The control portion 11 receiving the request distributes a web page for registering a project to the personal computer system PC of the request source. The web page allows the request source to input sets of user IDs as the information for specifying the project manager and the information for specifying each agency selected by the project manager respectively, and sequence information defining the sequence of performance of service of each agency (the sequence of data delivery among the agencies). Specifically the sequence information is expressed by a permutation of the user IDs. Incidentally, in the following description, each agency specified by each registered set of user IDs will be referred to as “agency belonging to the project”.

In addition, the control portion 11 accepts target information in which a print output machine available in a final output process is set as a remarkable print output machine by way of example, while the device ID of the remarkable print output machine is associated with factor information for estimating the properties of a printing result, such as the kind of paper. Then, the control portion 11 issues a unique project ID, and stores the input user IDs, sequence information and target information as a project database into the disk unit 13 using the issued project ID as a key, as shown in FIG. 3.

Further, the control portion 11 may accept setting about the expiration of the project, and register the information of the expiration into the project database.

In addition, the control portion 11 issues an access key proper to the project, and distributes the issued access key to each agency belonging to the project. Here, specifically, the access key can be generated using an encryption key based on common-key cryptography. In this case, the access key encrypted with a public key set in advance for each agency based on common-key cryptography is distributed to the agency. The access key is used in a data sharing process which will be described later.

[Information Generating Process]

The control portion 11 further performs a process for generating information for matching the color reproducibility of a print output machine available in each agency with the color reproducibility of the remarkable print output machine specified by the target information, so as to simulate the color reproducibility of the remarkable print output machine using the print output machine available in the agency. Here, a print output machine to be used in a final output process is set as the remarkable print output machine. Accordingly, this information is generated based on the comparison between the color-measuring result data from the device and printing paper in the target print output machine to be used in the final output process and the color-measuring result data about the print output machine available in the agency which will be a data delivery destination. Specifically, the information includes parameters for converting color information included in the sent data.

That is, in the data to be delivered, information of colors to be used on prints described by the data is included as information of a color space such as CMYK, RGB or L*a*b. Accordingly, the information of each color is converted with predetermined parameters, and the converted data is provided to the delivery destination. Thus, the state of color reproduction in the printing result using the device and printing paper in the remarkable print output machine is matched with that in the printing result in the agency of the delivery destination. Here, the conversion may be based on a conversion process similar to the conversion disclosed in JP-A-2002-290756.

In addition, this information can be defined in a round-robin manner among devices included in the device database. In the system according to this embodiment, therefore, this information is associated with either the information for specifying each agency (for example, user ID) or the device ID thereof, and stored in the storage portion 12 as device link profile information. When each agency belongs to a plurality of projects, a remarkable print output machine in one of the projects may differ from that in another. In consideration of such a situation, the device link profile information may include information for specifying the remarkable print output machine indirectly or directly, such as the project ID or the device ID of the remarkable print output machine.

Specifically, when each agency has one available print output machine, the device ID thereof and the generated parameters associated therewith are stored as device link profile information in the storage portion 12.

Thus, a database of device link profile information is formed in the storage portion 12. Incidentally, one of the features of this embodiment is that in consideration of a comparatively large load in processing for generating the device link profile information, the device link profile information is generated and stored in the storage portion 12 in advance, that is, the device link profile information is generated and stored in the storage portion 12 as soon as the project is defined though data has not yet been delivered among the agencies actually.

In addition, the device link profile information is used for delivering data from one agency to another. For example, when data is delivered from a first agency to a second agency, device link profile information including information for specifying the second agency is read from the storage portion 12 and used. Incidentally, in this event, a plurality of print output machines in the second agency may have been registered. In such a case, device link profile information associated with the device ID of a print output machine designated from each agency is used. Alternatively, in this case, device link profile information associated with the device ID designated as default in advance may be used selectively, or device link profile information associated with each device ID may be generated with priority being given to the device link profile information associated with the device ID designated as default.

Another feature in the first embodiment is that with reference to and on the basis of the sequence information associated with each project ID in the project database, device link profile information to be generated may be restricted or the sequence with which device link profile information will be generated may be adjusted. That is, the generation of device link profile information about agencies to which data will not be delivered may be suppressed with reference to the sequence information.

For example, assume that the sequence information defines data delivery from a production agency to a prepress agency while not defining direct data delivery from any other agency belonging to the project to the production agency. In this case, the control portion 11 makes control to prevent the generation of device link profile information including information for specifying the production agency, that is, information for simulating the color reproducibility of the remarkable print output machine using the print output machine on the production agency side.

[Data Sharing Process]

The control portion 11 generates a web site for each project, stores the web site in the disk unit 13, accepts upload of data from each agency belonging to the project, and retains the data. In addition, when a request to acquire the retained data is received from an agency belonging to the project, the control portion 11 distributes the data corresponding to the acquisition request. In this embodiment, any illegitimate access to the web site is prevented using a public key certificate of each agency, which certificate is set in advance in the personal computer system PC of the agency.

[Data Delivery Process]

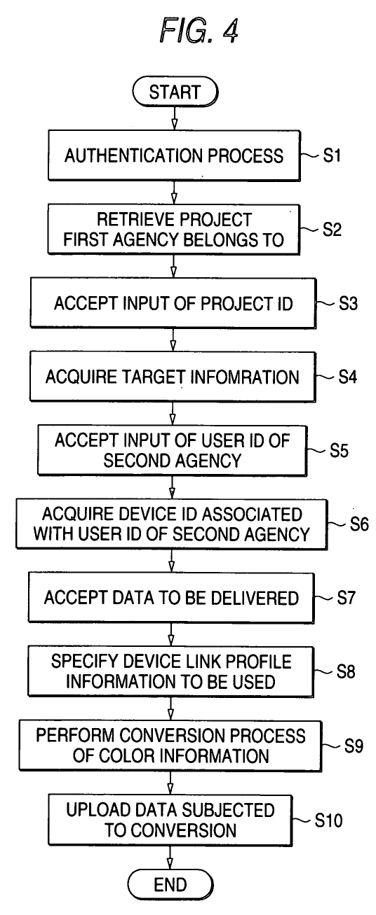

For each project, the control portion 11 performs a process for supporting data delivery among the agencies belonging to the project. That is, from an agency (first agency) which will be a data delivery source, the control portion 11 receives authentication information of the first agency, and starts a process as shown in FIG. 4. First, the control portion 11 compares the authentication information with information stored in the user database, so as to examine whether the first agency is a legitimate user or not (authentication step; S1). Here, when it is confirmed that the first agency is a legitimate user, the control portion 11 next retrieves projects the first agency belongs to, from the project database (S2). As a result of the retrieval, a list of the projects the first agency belongs to is transmitted to the personal computer system PC of the first agency so as to allow the first agency to specify a project ID of a project associated with the data the first agency will deliver (S3). Here, when a project ID is specified, the control portion 11 acquires target information associated with the project ID (S4).

Next, the control portion 11 acquires a list of agencies belonging to the project, which list is associated with the project. ID. The control portion 11 transmits the list of agencies to the personal computer system of the first agency so as to allow the first agency to specify an agency (second agency) which will be a data delivery destination (S5). Here, when the user ID of the second agency is specified, the control portion 11 acquires a device ID associated with the user ID (S6). When there are a plurality of device IDs associated with the user ID of the second agency, color-measuring result data associated with a device ID of the device IDs designated as default may be acquired selectively.

Next, the control portion 11 accepts data to be delivered (S7). The control portion 11 associates information (history information) indicating the acceptance of data from the first agency with the project ID, and stores the history information into the disk unit 13. The history information is generated whenever each agency gives an instruction to deliver data, and the generated history information is stored as a history database in the disk unit 13.

In addition, it is preferable that the data to be delivered is formed in a portable data format such as Adobe's PDF (Portable Document Format). Specifically, in the system according to this embodiment, the data can be accepted using PDFTansit™.

Next, the control portion 11 retrieves the device ID included in the target information defined in the project and the device link profile information including the user ID of the second agency acquired in Step 5, from the device link profile information database stored in the disk unit 13 (S8). Based on the device link profile information obtained as a result of the retrieval, the control portion 11 converts the color information of the data accepted in Step S7 (color conversion step; S9).

Incidentally, when there are a plurality of device IDs associated with the second agency and there are retrieved a plurality of pieces of device link profile information in Step S8, the control portion 11 may allow the first agency to designate a piece of device link profile information to be used. Alternatively, the control portion 11 may use a piece of device link profile information associated with the device ID designated as default by each agency in advance.

Then, the control portion 11 stores the converted data into a location accessible from the web site of the project associated with the project ID specified in Step S3 (S10), and notifies the personal computer system of the agency specified as the second agency, of the fact that data delivery has been requested. Then the control portion 11 terminates the process. This notification may be based on electronic mail by way of example. Thus, the data stored in Step S10 will be acquired by the second agency soon.

Incidentally, here, the control portion 11 performs not only the color conversion process but also a RIP process. That is, data subjected to a RIP process using the data subjected to the color conversion process is provided to the delivery destination in place of the data per se subjected to the color conversion process or together with the data subjected to the color conversion process or the data not yet subjected to the color conversion process. That is, one of (1) only the data subjected to the RIP process, (2) a set of the data subjected to the color conversion process and data subjected to the RIP process, (3) a set of the data not yet subjected to the color conversion process (that is, the data per se accepted in Step S7) and the data subjected to the RIP process, (4) a set of the data not yet subjected to the color conversion process, the data subjected to the color conversion process and the data subjected to the RIP process may be provided. When such a set is provided, an image data format such as wrapped PDF or TIFF may be used, or compression processing may be performed.

When the RIP process is performed on the print service support system 101 in such a manner, such a problem that there occurs a difference in printing result between agencies due to a difference between the fonts possessed by one agency and the fonts possessed by the other is prevented.

Further, the control portion 11 may perform a so-called preflight check before the RIP process. The preflight check includes a check of a color space, a check of image data or the like, verification of text, verification of layout, and so on.

[Work Flow Management Process]

In addition, by use of the web site used in the data sharing process, the control portion 11 provides information about the state of data delivery among the agencies so as to achieve the management of the work flow. Specifically, the control portion 11 generates a web page for providing the sequence information and the history information generated in the data delivery process, and distributes the web page to the agency-side personal computer systems PC.

[Second Embodiment]

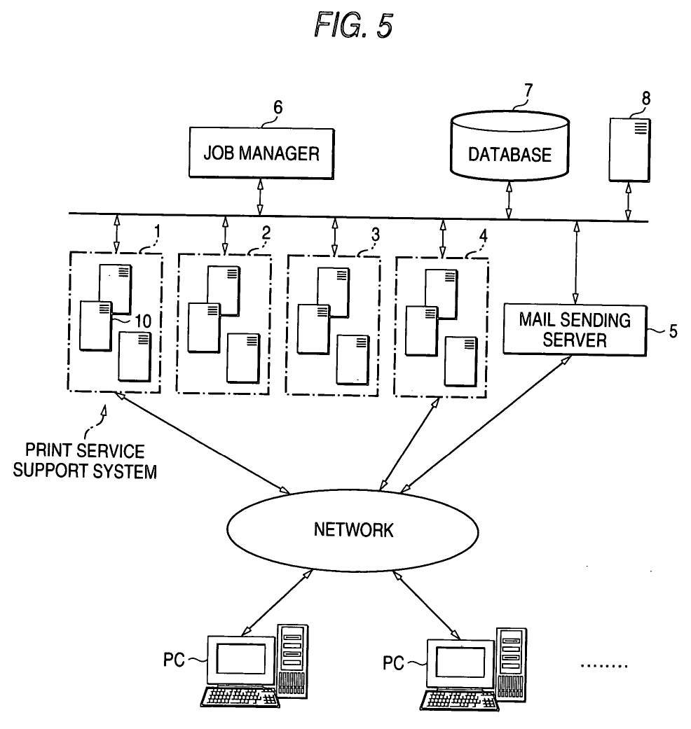

A system according to a second embodiment of the invention is specifically constituted by a web server group 1 as a data acceptance server group, a data check server group 2, a data processing server group 3, a format processing server group 4 as a data delivery server group, a mail sending server 5, a job manager 6, a database 7 and a registration management server 8, which are connected with one another through a LAN (Local Area Network), as shown in FIG. 5. In addition, the web server group 1 and the format processing server group 4 are connected via a network to personal computer systems PC disposed in agencies engaged in producing prints.

Here, each of the web server group 1, the data check server 2, the data processing server group 3 and the format processing server group 4 includes one or more server units 10.

Each control portion 11 operates in accordance with a program stored in a disk unit 13. Specifically, a control portion 11 of each server unit 10 belonging to the web server group 1 operates in accordance with a web server program stored in a disk unit 13 thereof; a control portion 11 of each server unit 10 belonging to the data check server group 2 operates in accordance with a data check program stored in a disk unit 13 thereof; a control portion 11 of each server unit 10 belonging to the data processing server group 3 operates in accordance with a ripper program stored in a disk unit 13 thereof; a control portion 11 of each server unit 10 belonging to the format processing server group 4 operates in accordance with a format processing program stored in a disk unit 13 thereof; a control portion 11 of the server unit 10 belonging to the mail sending server 5 operates in accordance with a mail sending program stored in a disk unit 13 thereof; and a control portion 11 of the server unit 10 belonging to the job manager 6 operates in accordance with a job management program stored in a disk unit 13 thereof.

For example, the job management program is to make the server unit 10 perform a process for accepting registration of agencies or registration of projects, a process for allowing a plurality of agencies in each project to share data, a process for performing data delivery, a process for managing a work flow in each project, and a process for managing a production history. The ripper program is to make the server unit 10 perform a process for generating information for simulating the properties of a printing result in a remarkable print output machine, such as color reproducibility in a print output machine available in each agency, and a process for providing the generated information. Specific contents of each process of each program will be described in detail later.

A storage portion 12 stores programs to be executed by the control portion 11. In addition, the storage portion 12 operates as a work memory of the control portion 11. The disk unit 13 stores information inputted from the control portion 11. The information stored in the disk unit 13 is set to be browsable from other server units 10.

Incidentally, each of the mail sending server 5, the job manager 6 and the registration management server 8 has a configuration similar to each server unit 10, except that a program to be executed by the control portion 11 and stored in the storage portion 12 has different contents. In addition, the disk unit 13 is not always required in each of the mail sending server 5, the job manager 6 and the registration management server 8.

[Registration Management Server]

First, description will be made on the operation of the registration management server 8. Information of each agency using the system according to this embodiment is transmitted to the registration management server 8, and set as a target of a registration process in advance. That is, the control portion 11 of the registration management server 8 (hereinafter the eighth alphabet “h” will be suffixed to each member of the registration management server 8 diacritically in the following description, for example, the control portion 11 of the registration server 8 will be expressed as “control portion 11h”) also operates as a web server by way of example, accepting an access from a personal computer system PC of an agency wanting to register itself, starting up a module for an agency registration process stored in the storage portion 12h so as to provide a web page for user registration, and allowing the agency to input and submit general information such as an agency name and a contact address as well as authentication information such as a registration user name and a password.

In addition, the control portion 11h provides a device registration screen for accepting an input of information for specifying a print output machine the user can use. Here, for example, the maker name, device name and the like of the print output machine are inputted. When a plurality of pieces of information specifying print output machines have been received from the user, the control portion 11h makes the user designate one of the plural print output machines as a so-called default print output machine the user uses mainly.

The control portion 11h issues an identifier (user ID) proper to the user and an identifier (device ID) proper to each print output machine, and gives notification of the user ID and the device ID to the user of the access source.

Then, the control portion 11h distributes color-measuring patch data stored in advance in the storage portion 12h to the personal computer system PC of the access source in accordance with a protocol such as HTTP or FTP.

The control portion 11h receives the color-measuring result data and the device ID associated therewith. The control portion 11h associates the device ID and the color-measuring result data with each other and stores them in a database 7.

As a user database obtained as a result of the registration process, as shown in FIG. 3, in the data base 7, the authentication information such as a user name and a password, the general information, and the information for specifying one or more registered device IDs and one of the device IDs designated as default are stored in association with one another using the user ID as a key. In addition, for each device ID, the color-measuring result data received in association with the device ID is stored as a device database in the database 7.

Incidentally, in the second embodiment, registration is done for each user, and all the users using this system in each agency are registered on an individual basis. However, registration may be done based on an agency name representing each agency.

In addition, in the system according to the second embodiment, an agency as a project manager accepting a request from a client selects other agencies to be engaged in producing the requested prints, and registers information for specifying the project manager per se and information for specifying each selected agency. That is, the agency as the project manager acquires, from each selected agency, user IDs associated with users in the agency in advance. Then, the project manager makes a request to the registration management server 8 for project registration. Incidentally, the project manager may be replaced by another agency halfway.

The control portion 11h of the registration management server 8 receiving the request distributes a web page for registering a project to the personal computer system PC of the request source. The web page allows the request source to input sets of user IDs as the information for specifying the project manager and the information for specifying each agency selected by the project manager respectively, and sequence information defining the sequence of performance of service of each agency (the sequence of data delivery among the agencies). Specifically, the sequence information is expressed by a permutation of the user IDs. Incidentally, in the following description, each agency specified by each registered set of user IDs will be referred to as “agency belonging to the project”.

In addition, the control portion 11h of the registration management server 8 accepts target information in which a print output machine available in a final output process is set as a remarkable print output machine by way of example, while the device ID of the remarkable print output machine is associated with factor information for estimating the properties of a printing result, such as the kind of paper. Then, the control portion 11h issues a unique project ID, and stores the input user IDs, sequence information and target information as a project database in the database 7 using the issued project ID as a key, as shown in FIG. 4.

Further, the control portion 11h of the registration management server 8 may accept setting about the expiration of the project, and register the information of the expiration into the project database.

In addition, the control portion 11h of the registration management server 8 issues an access key proper to the project, and distributes the issued access key to each agency belonging to the project. Here, specifically, the access key can be generated using an encryption key based on common-key cryptography. In this case, the access key encrypted with a public key set in advance for each agency based on common-key cryptography is distributed to the agency. The access key is used in a data sharing process which will be described later.

The control portion 11h of the registration management server 8 further performs a process for generating information for matching the color reproducibility of a print output machine available in each agency with the color reproducibility of the remarkable print output machine specified by the target information, so as to simulate the color reproducibility of the remarkable print output machine using the print output machine available in the agency. Here, a print output machine available in the final output process is set as the remarkable print output machine. Accordingly, this information is generated based on the comparison between the color-measuring result data from the device and printing paper in the target print output machine to be used in the final output process and the color-measuring result data about the print output machine available in the agency which will be a data delivery destination. Specifically, the information includes parameters for converting color information included in the sent data.

In addition, this information can be defined in a round-robin manner among devices included in the device database. Therefore, in the system according to this embodiment, this information is associated with either the information for specifying each agency (for example, user ID) or at least one of the device IDs of devices the agency uses, and stored in the database 7 as device link profile information (corresponding to the predetermined processing parameters in the invention). Further, when each agency belongs to a plurality of projects a remarkable print output machine in one of the projects may differ from that in another. In consideration of such a situation, the device link profile information may include information for specifying the remarkable print output machine indirectly or directly, such as the project ID or the device ID of the remarkable print output machine.

Specifically, when each agency has one available print output machine, the device ID thereof and the generated parameters associated therewith are stored as device link profile information in the database 7.

Thus, a database of device link profile information is formed in the database 7. Incidentally, one of the features of this embodiment is that in consideration of a comparatively large load in processing for generating the device link profile information, the device link profile information is generated and stored in the database 7 in advance, that is, the device link profile information is generated and stored in the database 7 as soon as the project is defined though data has not yet been delivered among the agencies actually.

In addition, the device link profile information is used for delivering data from one agency to another. For example, when data is delivered from a first agency to a second agency, device link profile information including information for specifying the second agency is read from the database 7 and used by the data processing server group 3 or the like. Incidentally, in this event, a plurality of print output machines in the second agency may have been registered. In such a case, device link profile information associated with the device ID of a print output machine designated from each agency is used. Alternatively, in this case, device link profile information associated with the device ID designated as default in advance may be used selectively, or device link profile information associated with each device ID may be generated with priority being given to the device link profile information associated with the device ID designated as default.

Another feature in the second embodiment is that with reference to and on the basis of the sequence information associated with each project ID in the project database, device link profile information to be generated may be restricted or the sequence with which device link profile information will be generated may be adjusted. That is, the generation of device link profile information about agencies to which data will not be delivered may be suppressed with reference to the sequence information.

For example, assume that the sequence information defines data delivery from a production agency to a prepress agency while not defining direct data delivery from any other agency belonging to the project to the production agency. In this case, the control portion 11h of the registration management server 8 makes control to prevent the generation of device link profile information including information for specifying the production agency, that is, information for simulating the color reproducibility of the remarkable print output machine using the print output machine on the production agency side.

Incidentally, device link profile information between a print output machine in each agency belonging to the project and the remarkable print output machine is generated in this stage.

Further, the control portion 11h of the registration management server 8 may receive information (preflight profile information) defining a check condition to be used in a preflight check process from the agency side together with target information, and store the information in the database 7 together with the target information.

[Web Server Group]

As soon as a new project is registered in the database 7, the control portion 11 of a server unit 10 belonging to the web server group 1 (hereinafter the first alphabet “a” will be suffixed to each member of each server unit belonging to the web server group 1 diacritically in the following description, for example, the control portion 11 of the server unit will be expressed as “control portion 11a”) generates a web site about the project, stores the web site in the disk unit 13, accepts upload of data from each agency belonging to the project, and retains the data. In addition, when a request to acquire the retained data is received from an agency belonging to the project, data corresponding to the acquisition request is distributed to the agency. In this embodiment, any illegitimate access to the web site is prevented using a public key certificate of each agency, which certificate is set in advance in the personal computer system PC of the agency. This processing has been known broadly, for example, as communication using SSL (Secure Socket Layer), and detailed description thereof will be omitted.

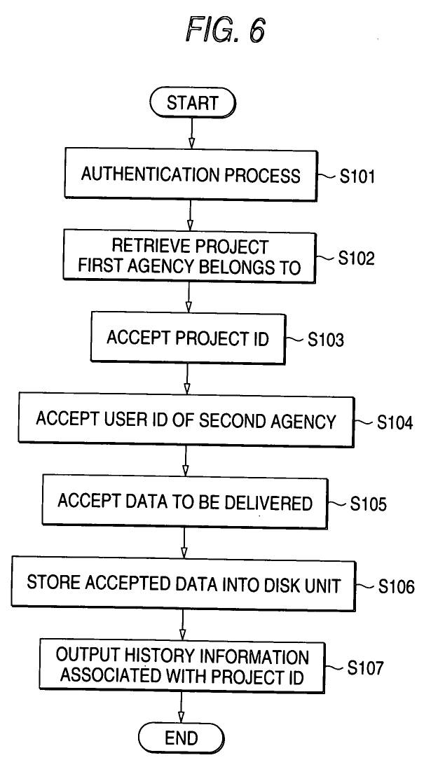

For each project, the control portion 11a performs a process for supporting data delivery among the agencies belonging to the project. That is, from an agency (first agency) which will be a data delivery source, the control portion 11a receives authentication information of the first agency, and starts a process as shown in FIG. 6. First, the control portion 11a compares the authentication information with information stored in the user database, so as to examine whether the first agency is a legitimate user or not (authentication step; S101) Here, when it is confirmed that the first agency is a legitimate user, the control portion 1a next retrieves projects the first agency belongs to, from the project database (S102). As a result of the retrieval, a list of the projects the first agency belongs to is transmitted to the personal computer system PC of the first agency so as to allow the first agency to specify a project ID of a project related to the data the first agency will deliver (S103).

Next, the control portion 11a acquires a list of agencies belonging to the project, which list has been associated with the project ID and registered in the database 7. The control portion 11a transmits the list of agencies to the personal computer system PC of the first agency so as to allow the first agency to specify a user ID of an agency (second agency) which will be a data delivery destination (S104).

Next, the control portion 11a accepts data to be delivered (S105), and stores the data into the disk unit 13a (S106). The control portion 11a associates information (history information) indicating the acceptance of data from the first agency with the project ID, and supplies the history information to the job manager 6 (S107). Then, the control portion 11a terminates the process. The history information is generated whenever each agency gives an instruction to deliver data, and the generated history information is supplied to the job manager 6 and stored as a history database in the database 7 by the job manager 6.

[Data Check Server Group]

In response to and in accordance with the notification (which may include reference information indicating a storage location) of the fact that data to be processed has been stored in the disk unit 13a of the server unit 10 belonging to the web server group 1, the control portion 11 of a server unit 10 belonging to the data check server group 2 (hereinafter the second alphabet “b” will be suffixed to each member of each server unit belonging to the data check server group 2 diacritically in the following description, for example, the control portion 11 of the server unit will be expressed as “control portion 11b”) extracts the data to be processed from the disk unit 13a of the server unit 10 belonging to the web server group 1, and performs a so-called preflight check. When preflight profile information of each agency has been stored in the database 7, the preflight check is performed as follows. That is, the preflight profile information associated with the user ID of the second agency specified in Step S104 is extracted from the database 7. It is examined whether the data to be processed meets the conditions defined by the extracted preflight profile information, or not. Here, the preflight profile information includes definitions of conditions such as designation of a color space, unprocessable designation possibly included in image data (for example, designation of transparency maybe unprocessable for some printing agencies), verification of text, verification of layout, and so on. The control portion 11b supplies information indicating the occurrence of an error to the job manager 6 when the data to be processed does not meet the conditions.

On the contrary, when the data to be processed meets the conditions, the control portion 11b stores the data to be processed into the disk unit 13b, and supplies information indicating the completion of checking the data, to the job manager 6.

[Data Processing Server Group]

In response to and in accordance with the notification (which may include reference information indicating a storage location) of the fact that data to be processed has been stored in the disk unit 13b of the server unit 10 belonging to the data check server group 2, the control portion 11 of a server unit 10 belonging to the data processing server group 3 (hereinafter the third alphabet “c” will be suffixed to each member of each server unit 10 belonging to the data processing server group 3 diacritically in the following description, for example, the control portion 11 of the server unit will be expressed as “control portion 11c”) extracts the data to be processed from the disk unit 13b of the server unit 10 belonging to the data check server group 2, and stores the data into the storage portion 12c.

The control portion 11c of the server unit 10 belonging to the data processing server group 3 acquires the project ID related to the aforementioned notification, and the user IDs of the first and second agencies authenticated by the server unit 10 belonging to the web server group 1, from the job manager 6, and acquires target information associated with the project ID, the device ID (delivery source device. ID) associated with the user ID of the first agency and the device ID (delivery destination device ID) associated with the user ID of the second agency, from the database 7.

Next, the control portion 11c retrieves device link profile information associated with the acquired delivery source device ID and delivery destination device ID, from the device link profile information database stored in the database 7. On the basis of the device link profile information obtained as a result of the retrieval, the control portion 11c converts the color information of the data to be processed (pre-conversion), which data has been extracted from the disk unit 13b of the server unit 10 belonging to the data check server group 2. Further, the control portion 11c retrieves device link profile information associated with the device ID associated with the user ID of the second agency and the device ID of the remarkable print output machine to be used in a final output process, from the database 7. On the basis of the device link profile information obtained as a result of the retrieval, the control portion 11c further converts the color information of the data to be processed (color conversion process). Thus, the conditions at the time of final output can be simulated in the device on the second agency side. In addition, here, pre-conversion is performed on the assumption that the data delivered from the first agency meets the color reproducibility of the device in the first agency. When the data delivered from the first agency is data independent of any device, this pre-conversion is not always required.

Incidentally, there maybe a plurality of device IDs when a device ID associated with the user ID of the first agency or the second agency is to be acquired. In such a case, color-measuring result data associated with the device ID designated as default among the device IDs may be acquired selectively, or the first agency or the second agency may be allowed to designate device link profile information to be used.

In addition, the control portion 11c performs not only the color conversion process but also a RIP process. That is, data subjected to a RIP process using the data subjected to the color conversion process is provided to the delivery destination in place of the data per se subjected to the color conversion process or together with the data subjected to the color conversion process or the data not yet subjected to the color conversion process. That is, one of (1) only the data subjected to the RIP process, (2) a set of the data subjected to the color conversion process and data subjected to the RIP process, (3) a set of the data not yet subjected to the color conversion process (that is, the data per se as a target of processing) and the data subjected to the RIP process, (4) a set of the data not yet subjected to the color conversion process, the data subjected to the color conversion process and the data subjected to the RIP process may be provided. When the RIP process is performed on the print service support system side in such a manner, such a problem that there occurs a difference in printing result between agencies due to a difference between the fonts possessed by one agency and the fonts possessed by the other is prevented.

The control portion 11c stores data subjected to the color conversion process or the RIP process thus, into the disk unit 13c, and supplies information indicating the completion of processing the data, to the job manager 6.

[Format Processing Server Group]

In response to and in accordance with the notification (which may include reference information indicating a storage location) of the fact that data to be processed has been stored in the disk unit 13c of the server unit 10 belonging to the data processing server group 3, the control portion 11 of a server unit 10 belonging to the format processing server group 4 (hereinafter the fourth alphabet “d” will be suffixed to each member of each server unit belonging to the format processing server group 4 diacritically in the following description, for example, the control portion 11 of the server unit will be expressed as “control portion 11d”) extracts the data to be processed from the disk unit 13c, converts the data to be processed into a predetermined format, stores the converted data into the disk unit 13d, and supplies information indicating the completion of processing the data, to the job manager 6 together with the information specifying the storage location of the data.

Here, an image data format such as wrapped PDF or TIFF may be adopted as the predetermined format, or compression processing may be performed.

The control portion 11d also operates as a web server. In response to an access from the personal computer system PC of the second agency, the control portion 11d delivers data stored in the disk unit 13d, to the personal computer system PC of the second agency.

Specifically, any illegitimate access to the control portion 11d is prevented using a public key certificate of each agency, which certificate is set in advance in the personal computer system PC of the second agency. This processing has been known broadly, for example, as communication using SSL (Secure Socket Layer), and detailed description thereof will be omitted.

[Job Manager]

When the information (history information) indicating the acceptance of data from the first agency and the project ID are received from the server unit 10 belonging to the web server group 1, the job manager 6 stores the history information into the database 7, and sends each server unit 10 belonging to the data check server group 2 a notification that the data to be processed has been stored in a storage location in the disk unit 13a of one of the server units 10 belonging to the web server group 1, together with reference information for specifying the storage location.

The data check server group 2 is designed so that, of the server units 10 belonging thereto, one server unit 10 replying acknowledgement to the notification most quickly processes the data.

In the same manner, when receiving a notification of the completion of processing from the data check server group 2, the job manager 6 sends each server unit 10 belonging to the data processing server group 3 a notification that the data to be processed has been stored in a specific storage location of a disk unit 13b belonging to the data check server group 2. In addition, when receiving a notification of the completion of processing from the data processing server group 3, the job manager 6 sends each server unit 10 belonging to the format processing server group 4 a notification that the data to be processed has been stored in a specific storage location of a disk unit 13c belonging to the data processing server group 3.

Each of the data processing server group 3 and the format processing server group 4 is also designed so that, of the server units 10 belonging thereto, one server unit 10 replying acknowledgement to the notification most quickly processes the data.

The job manager 6 further acquires information of the completion of processing the data from a server unit 10 belonging to the format processing server group 4 together with information for specifying the storage location of the data. The job manager 6 makes the mail sending server 5 send an electronic mail addressed to the mail address of the second agency which will be a delivery destination of the data. The electronic mail includes URL information for gaining access to the acquired storage location of the data in the server unit 10 belonging to the format processing server group 4.

Thus, each user on the second agency side can receive the data to be delivered (after the predetermined authentication process), if the user can gain access to the URL included in the electronic mail.

In addition, the job manager 6 may operate also as a web server, providing information about the state of delivery of data among agencies so as to achieve the management of a work flow. Specifically, a web page for providing the history information generated in the course of processing from the acceptance of data to the delivery thereof as described above may be generated and distributed to the agency-side personal computer systems PC.

Upon generation of history information, the job manager 6 issues a unique job ID and associates the job ID with the history information, while making communication to each server unit 10 belonging to each server group 1-4 with the job ID being added to the aforementioned notification (communication). In addition, processing state information in each server group, such as the existence of reception of the notification, the date and hour of reception of the notification, and the like, may be managed for each job ID.

In the processing of the job manager 6 as a web server, the information such as the existence of reception of notification managed for each job ID may be distributed to each agency (first, second agency) related to the history information associated with the job ID or to each agency belonging to the project associated with the history information, as data indicating the processing state of data related to the job ID.

A web site generated thus when the job manager 6 operates as a web server may be generated for each agency (each user in each agency) so that information about a job the user is engaged in is distributed to the user within the web page.

[Installation of Fonts or the like into Data Processing Server]

Of data required in a RIP process or the like in a server unit 10 belonging to the aforementioned data processing server group 3, some data (e.g. font data in Windows® server) requires installation into an operating system of the server unit 10 and reboot, rehash or the like of the server unit 10, for a period of time when any other processing cannot be performed during the processing of installation of the data. In such a case, the installation of the data can be performed in the following procedure.

The performance of this procedure requires a data providing server for providing the data to be installed. A not-shown server may be prepared specially as the data providing server, or one server unit 10, the job manager 6 or the like may be used as the data providing server.

When the data providing server stores data to be installed, and each server unit 10 belonging to the data processing server group 3 receives an instruction to install the data (from the job manager 6, a not-shown terminal of a system manager, or the like), the server unit 10 examines the current processing condition. When the server unit 10 is processing data, the server unit 10 waits till the processing of the data is terminated. Even if a notification that there is new data to be processed is received from the job manager 6 during this wait, the server unit 10 may be prevented from performing the processing of data related to this notification.

Then, when the data processing is terminated, the server unit 10 acquires the data to be installed from the data providing server, and performs the processing of installation of the data.

In addition, in the case where each server unit 10 waits as described above, the data providing server may perform a so-called arbitration process in order to prevent all the server units 10 from waiting simultaneously. That is, each server unit 10 wanting to wait is made to send a request to wait to the data providing server. The data providing server gives an instruction to wait sequentially to the server units 10 each issuing such a request in a predetermined sequence (which can be determined in accordance with predetermined priority, the sequence of the notification to want to wait, the current processing load, and so on).

In this case, the server unit 10 keeps processing new data without waiting till the server unit 10 receives the instruction to wait as a reply to the request to want to wait.

[Third Embodiment]

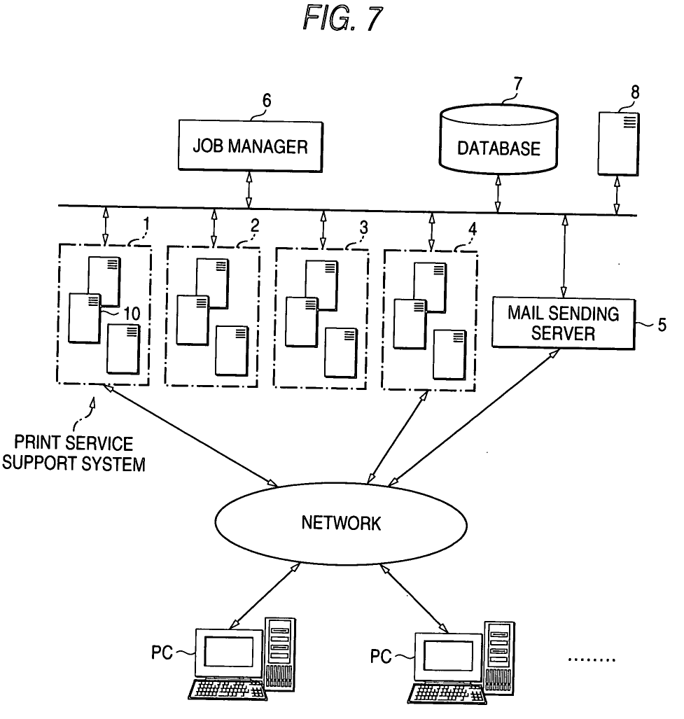

A system according to a third embodiment of the invention is specifically constituted by a web server group 1 as a data acceptance server group, a preprocessing server group 102, a data processing server group 3, a format processing server group 4 as a data delivery server group, a mail sending server 5, a job manager 6, a database 7 and a registration management server 8, which are connected with one another through a LAN (Local Area Network), as shown in FIG. 7. In addition, the web server group 1 and the format processing server group 4 are connected via a network to personal computer systems PC disposed in agencies engaged in producing prints.

Here, each of the web server group 1, the preprocessing server group 102, the data processing server group 3 and the format processing server group 4 includes one or more server units 10.

Each control portion 11 operates in accordance with a program stored in a disk unit 13. Specifically, a control portion 11 of each server unit 10 belonging to the web server group 1 operates in accordance with a web server program stored in a disk unit 13 thereof; a control portion 11 of each server unit 10 belonging to the preprocessing server group 102 operates in accordance with a data check program stored in a disk unit 13 thereof; a control portion 11 of each server unit 10 belonging to the data processing server group 3 operates in accordance with a ripper program stored in a disk unit 13 thereof; a control portion 11 of each server unit 10 belonging to the format processing server group 4 operates in accordance with a format processing program stored in a disk unit 13 thereof; a control portion 11 of the server unit 10 belonging to the mail sending server 5 operates in accordance with a mail sending program stored in a disk unit 13 thereof; and a control portion 11 of the server unit 10 belonging to the job manager 6 operates in accordance with a job management program stored in a disk unit 13 thereof.

[Preprocessing Server Group]

In response to and in accordance with the notification (which may include reference information indicating a storage location) of the fact that data to be processed has been stored in the disk unit 13a of the server unit 10 belonging to the web server group 1, the control portion 11 of a server unit 10 belonging to the preprocessing server group 102 (hereinafter the second alphabet “b” will be suffixed to each member of each server unit belonging to the preprocessing server group 102 diacritically in the following description, for example, the control portion 11 of the server unit will be expressed as “control portion 11b”) extracts the data to be processed from the disk unit 13a of the server unit 10 belonging to the web server group 1 and performs a so-called preflight check on the data. When preflight profile information of each agency has been stored in the database 7, the preflight check is performed as follows. That is, the preflight profile information associated with the user ID of the second agency specified in Step S104 is extracted from the database 7. It is examined whether the data to be processed meets the conditions defined by the extracted preflight profile information, or not. Here, the preflight profile information includes definitions of conditions such as designation of a color space, unprocessable designation possibly included in image data (for example, designation of transparency may be unprocessable for some printing agencies), verification of text, verification of layout, and soon. The control portion 11b supplies information indicating the occurrence of an error to the job manager 6 when the data to be processed does not meet the conditions.

On the contrary, when the data to be processed meets the conditions, the control portion 11b stores the data to be processed into the disk unit 13b, and supplies information indicating the completion of checking the data, to the job manager 6.

Further, the control portion 11b may perform a predetermined correction process such as a font substitution process or a bitmap image substitution process in addition to the preflight check process. Specifically, when definitions of letter forms (so-called font glyph provided as bitmap or vector data) of fonts used in the data to be processed, which definitions are to be used to output the fonts, are absent from the data to be processed, the control portion 11b acquires letter form definition information of the fonts used in the data, and rasterizes the fonts. Thus, the font portions of the data are rasterized. Alternatively, fonts not embedded in PDF may be converted into embedded fonts so that substantial rasterization can be achieved.

There may be a bitmap image corresponding to an image expressed by a bitmap image included in the data to be processed, and higher in resolution than the bitmap image in the data. In such a case, the control portion 11b may acquire the bitmap image higher in resolution, and substitutes the bitmap image higher in resolution for the bitmap image in the data. In this event, when information about the resolution of the device of the second agency which is a data delivery destination can be obtained from information about the device of the second agency, the substitution process may be performed only when the resolution of the bitmap image included in the data to be processed is lower than that in the information about the resolution.

Further, when an application which has generated the data to be processed can be specified, a process of examining and correcting the data to be processed may be performed based on bug information determined in advance in connection with the application. For example, when it has been already known that there is a bug in parameter setting about a specific command sequence in PDF data generated by a specific version V of an application A, information about the bug is associated with information for specifying the application A and the version V and stored in the database 7 in advance. Then, the control portion 11b examines the application and its version having generated the data to be processed, and retrieves, from the database 7, the bug information associated with the application and the version having generated the data. When finding the bug information, the control portion 11b corrects the data with reference to the bug information. In this case, the bug information is information for defining a pattern in which the bug will occur, and a pattern which should be substituted for the pattern. For example, assume that there is a bug in which PDF is outputted with designation of “/Range[0.0 1.0 (linefeed)]” having no closing parenthesis in place of “/Range[0.0 1.0] (linefeed)”. In such a case, “/Range[* (linefeed)” and “/Range[*] (linefeed)” are associated with each other, and retained.

The control portion 11b retrieves the pattern “/Range[* (linefeed)]” (here the retrieval is performed with the asterisk being regarded as a regular expression corresponding to any one or more characters). When the pattern is found in the retrieval, the pattern is replaced by “/Range[*] (linefeed)” (here the asterisk is to be replaced by a character string corresponding to the regular expression in the retrieval). Thus, the pattern “/Range [0.01.0 (linefeed)]” can be altered into the pattern “/Range [0.0 1.0] (linefeed)”.

Further, the control portion 11b may judge whether the data to be processed satisfies a predetermined providing condition or not, and provide the data subjected to the preflight check (or the data subjected to the preflight check and the correction process) directly to the second agency which is a delivery destination when the data satisfies the providing condition. Thus, it is possible to extract data (unprocessed data) subjected to no processing by the data processing server which will be described later. In this event, the control portion 11b may store the data to be processed, into the disk unit 13b, and supply the job manager 6 with information indicating the fact that checking the data has been completed, so as to allow the data processing server group 3 to perform the process which will be described next, and provide the data subjected to the process to the second agency (together with the unprocessed data). Alternatively, with reference to and in accordance with predetermined setting (indicating which data should be provided, the unprocessed data or the data subjected to the process by the data processing server group 3) for the user on the second agency side, the unprocessed data may be provided directly to the second agency, which is a delivery destination, when the setting indicates that the unprocessed data should be provided.

On the contrary, when the data to be processed does not satisfy the providing condition, the control portion 11b stores the data to be processed, into the disk unit 13b, and supplies the job manager 6 with information indicating that checking the data has been completed. Then, the process which will be described next is performed by the data processing server group 3.

Incidentally, the providing condition is, for example, a condition as to whether data has been approved or not, a condition as to whether there was an instruction from the project manager or not (there was an instruction to provide unprocessed data from the project manager for the project in the past or not).

For example, when the condition as to whether data has been approved or not is set as the providing condition, the control portion 11b judges whether the data to be processed is approved data (final data to be delivered to a printing office and printed therein) or not. When the data is approved data, the control portion 11b provides the data subjected to the preflight check (or the data subjected to the preflight check and the correction process) as approved data directly to the destination (second agency in this case) to which the approved data should be delivered, that is, to the agency (final output agency) equipped with a print output machine to be used in a final output process. For example, the control portion 11b operates as a web server, setting a part of the disk unit 13b as a public region made open by the web server, storing the data in this public region, and notifying the job manager 6 of the fact that the approved data has been ready to be provided. The job manger 6 receiving the notification makes the mail sending server 5 send the final output agency an electronic mail indicating a URL to the approved data stored in the public region. Thus, the data stored in the disk unit 13b can be acquired from the personal computer system PC on the final output agency side. Incidentally, the acquisition of the data may be based on cipher communication using SSL or the like.

Assume that setting is done thus so that approved data is provided directly to the final output agency. In such a case, when data to be processed has not been approved, the control portion 11b stores the data into the disk unit 13b, and supplies the job manager 6 with information indicating that checking the data has been completed. Then, the process which will be described next is performed by the data processing server group 3.

Here, the judgment as to whether the data to be processed has been approved or not can be made, for example, by predetermined conditions about the sequence information or the like, designation from the first agency which is a delivery source of the data, or the like. For example, when the arrangement of the user ID of a first agency and the user ID of a second agency corresponds to the arrangement in a tail portion of a permutation of user IDs indicated by the sequence information, data to be delivered from the first agency to the second agency can be judged to be approved.

Incidentally, here, the control portion 11b operates as a web server, providing the second agency with data satisfying the providing condition. However, in place of this, when the control portion 11b generates and stores data subjected to a preflight check (or data subjected to a preflight check and a correction process) in the disk unit 13b, and informs the job manager 6 of the completion of processing, the job manager 6 may judge whether the data satisfies a predetermined providing condition or not. In this case, when the data satisfies the providing condition, the job manager 6 does not allow the data processing server group 3 to process the data, but gives the format processing server group 4 (as a data deliver server group) an instruction to acquire the data stored in the disk unit 13b and process the data. Thus, the data subjected to the preflight check (or the data subjected to the preflight check and the correction process) is provided directly to the second agency without suffering the data processing which will be described next. In this case, each server unit 100f the format processing server group 4 may also provide the data directly without processing described later.

The data provided thus is rasterized, for example, on the second agency side. Specifically, when the data is approved data, the data is rasterized on the final output agency side, and printed by the final output machine.

[Data Processing Server Group]

In response to and in accordance with the notification (which may include reference information indicating a storage location) of the fact that data to be processed has been stored in the disk unit 13b of the server unit 10 belonging to the preprocessing server group 102, the control portion 11 of a server unit 10 belonging to the data processing server group 3 (hereinafter the third alphabet “c” will be suffixed to each member of each server unit 10 belonging to the data processing server group 3 diacritically in the following description, for example, the control portion 11 of the server unit 10 will be expressed as “control portion 11c”) extracts the data to be processed from the disk unit 13b of the server unit 10 belonging to the preprocessing server group 102, and stores the data into the storage portion 12c.

The control portion 11c of the server unit 10 belonging to the data processing server group 3 acquires, from the job manager 6, the project ID related to the notification, and the user IDs of the first and second agencies authenticated by the server unit 10 belonging to the web server group 1, and acquires, from the database 7, target information associated with the project ID, the device ID (delivery source device ID) associated with the user ID of the first agency and the device ID (delivery destination device ID) associated with the user ID of the second agency.

Next, the control portion 11c retrieves device link profile information associated with the acquired delivery source device ID and delivery destination device ID, from the device link profile information data base stored in the database 7. On the basis of the device link profile information obtained as a result of the retrieval, the control portion 11c converts the color information of the data to be processed (pre-conversion), which data has been extracted from the disk unit 13b of the server unit 10 belonging to the data check server group 2. Further, the control portion 11c retrieves, from the database 7, device link profile information associated with the device ID associated with the user ID of the second agency and the device ID of the remarkable print output machine to be used in the final output process. On the basis of the device link profile information obtained as a result of the retrieval, the control portion 11c further converts the color information of the data to be processed (color conversion process). Thus, the conditions at the time of final output can be simulated in the device on the second agency side. In addition, here, pre-conversion is performed on the assumption that the data delivered from the first agency meets the color reproducibility of the device in the first agency. When the data delivered from the first agency is data independent of any device, this pre-conversion is not always required.

[Job Manager]

When the information (history information) indicating the acceptance of data from the first agency and the project ID are received from the server unit 10 belonging to the web server group 1, the job manager 6 stores the history information into the database 7, and sends each server unit 10 belonging to the preprocessing server group 102 a notification that the data to be processed has been stored in a storage location in the disk unit 13a of one of the server units 10 belonging to the web server group 1, together with reference information for specifying the storage location.

The preprocessing server group 102 is designed so that, of the server units 10 belonging thereto, one server unit 10 replying acknowledgement to the notification most quickly processes the data.

In the same manner, upon reception of the notification of the completion of processing from the preprocessing server group 102, the job manager 6 sends each server unit 10 belonging to the data processing server group 3 a notification that the data to be processed has been stored in a specific storage location in the disk unit 13b belonging to the preprocessing server group 102. In addition, upon reception of the notification of the completion of processing from the data processing server group 3, the job manager 6 sends each server unit 10 belonging to the format processing server group 4 a notification that the data to be processed has been stored in a specific storage location in the disk unit 13c belonging to the data processing server group 3.

[Operation]

The system according to this embodiment has a configuration as described above, and operates as follows. Each agency wanting to carry out print service using the system according to the first embodiment registers information (color-measuring result data and the like) about a print output machine to be used by the agency itself, on the print service support system 101 side in advance.

An agency (for example, an advertising production agency) making a contract with a client to produce prints selects agencies required for carrying out the print service requested by the client. The agency registers, on the print service support system 101 side, information for specifying the selected agencies and sequence information for defining the sequence of data delivery among the agencies. Thus, the registration of a project is accepted.

When the project has been registered, a web page related to the project is generated, and an access key for gaining access to the web page of the project is issued. A notification of the access key is given to each selected agency.

When the project has been registered, the print service support system 101 generates device link profile information to be used for data delivery sequentially with reference to the sequence information (and the device ID of a print output machine specified as default by each agency associated with the sequence information) regardless of whether an instruction to deliver data has been given or not. The print service support system 101 stores the generated device link profile information into the disk unit 13.

Then, for example, when data generated by the advertising production agency and related to the advertising prints is delivered to a prepress agency, device link profile information in which the advertising production agency is set as a delivery source and the prepress agency is set as a delivery destination is read from the disk unit 13. The color information of the data to be delivered is converted using the device link profile information read thus. In addition, a RIP process is performed on the data, and the data subjected to the RIP process is provided to the prepress agency which is a delivery destination.

The prepress, agency carries out prepress service on the delivered data using a print output machine on the prepress agency side. In addition, the delivered data can be downloaded from the web page of the project. Thus, the advertising production agency as a project manager can refer to the processing state of the data (that is, the progress of the project).

Incidentally, data processed by each agency can be provided to the agency serving as the project manager. Thus, proofreading or the like can be performed by the project manager.

Each agency wanting to carry out print service using the system according to the second embodiment registers information (color-measuring result data and the like) about a print output machine to be used by the agency itself, on the print service support system 101 side in advance.

When a project has been registered, the print service support system generates device link profile information to be used for data delivery sequentially with reference to the sequence information (and the device ID of a print output machine specified as default by each agency associated with the sequence information) regardless of whether an instruction to deliver data has been given or not. The print service support system stores the generated device link profile information into the database 7.

Then, for example, when data generated by the advertising production agency and related to the advertising prints is sent to the web server group 1, the data is set as a target of processing, and managed together with a unique job ID. Then, a preflight check is performed on the data as a target of processing by a server unit 10 of the data check server group 2. Next, the device link profile information between a prepress agency as a delivery destination and the advertising production agency (delivery source) is read from the database 7 by a server unit 10 of the data processing server group 3. The color information of the data to be delivered is converted using the device link profile information read thus (pre-conversion). Further, the device link profile information between the prepress agency as a delivery destination and a printing agency as a final output agency is read from the database 7. The color information of the data to be delivered is converted using the device link profile information read thus. In addition, a RIP process is performed on the data, and the data subjected to the RIP process is converted into data in a predetermined format by a server unit 10 of the format processing server group 4.

When the converted data has been generated and stored in a server unit 10 of the format processing server group 4, information for specifying the storage location of the data is transmitted to the prepress agency as a delivery destination by electronic mail. When the prepress agency gains access to the storage location indicated by the electronic mail, the processed and formatted data is provided to the prepress agency.

The prepress agency outputs the delivered data by use of a print output machine on the prepress agency side. In the output result, the printing conditions in the final output machine have been simulated. The prepress agency carries out prepress service while observing the output result. In addition, when the state of processing the delivered data is provided, the advertising production agency as a project manager can refer to the processing state of the data (that is, the progress of the project).

Each agency wanting to carry out print service using the system according to the third embodiment registers information (color-measuring result data and the like) about a print output machine to be used by the agency itself, on the print service support system side in advance. In addition, in the following description, assume that the providing condition is a condition as to whether data to be processed has been approved or not.

For example, when data generated by the advertising production agency and related to the advertising prints is sent to the web server group 1, the data is set as a target of processing, and managed together with a unique job ID. Then, a preflight check is performed on the data as a target of processing by a server unit 10 of the preprocessing server group 102. Next, the device link profile information between a prepress agency as a delivery destination and the advertising production agency (delivery source) is read from the database 7 by a server unit 10 of the data processing server group 3. The color information of the data to be delivered is converted using the device link profile information read thus (pre-conversion). Further, the device link profile information between the prepress agency as a delivery destination and a printing agency as a final output agency is read from the database 7. The color information of the data to be delivered is converted using the device link profile information read thus. In addition, a RIP process is performed on the data, and the data subjected to the RIP process is converted into data in a predetermined format by a server unit 10 of the format processing server group 4.

When the data has been delivered in turn among the agencies and subjected to proofreading (including color proofreading) so as to be approved, there comes a final stage in which the data is, for example, delivered from the advertising production agency to a printing agency. In this final stage, the data delivered from the advertising production agency is sent to the web server group 1, a preflight check is performed on the data as a target of processing by a server unit 10 of the preprocessing server group 102, and the data subjected to the preflight check is distributed to the printing agency as it is. The printing agency performs a RIP process on the data, and performs printing.

[Modifications]

In addition, in an actual print service, for example, the printing agency may subcontract to another printing agency. Further, there is another request that the printing agency does not want any superordinate agency (for example, a project manager) to know such a subcontract. Accordingly, the print service support system may be adapted so that each agency can set a subproject not to allow any other agency of the project to refer to each agency belonging to the subproject. The subproject is registered fundamentally in the same manner as the project, and subjected to processing by the control portion 11.

Further, to deliver data, the agency which is a delivery source may be allowed to designate the resolution, the compression format or the like. That is, although the RIP process is generally performed in accordance with the resolution of the print output machine to be used on the delivery destination agency side, the delivery source may be allowed to designate the resolution of the RIP process. Alternatively, the delivery source agency may be allowed to designate which resolution to have priority, the resolution designated by the delivery source agency itself or the resolution of the print output machine to be used on the delivery destination agency side.

In addition, when the compression format is designated, for example, the delivery source agency may be allowed to designate a compression method (LZH method, JPEG method, or the like), lossless/lossy compression, and intensity (setting of compression ratio) in lossy compression. Also in this case, when a compression format can be determined based on the conditions related to the print output machine on the delivery destination side, the compression format may be used. On the other hand, when a compression format has been designated by the data delivery source, data compressed in the designated compression format is provided. Further, also in this case, an instruction as to which compression format to have priority, the compression format designated by the data delivery source or the compression format determined based on the conditions related to the print output machine on the delivery destination side, may be accepted from the data delivery source. Thus, data is compressed in accordance therewith.

In addition, device link profile information is not always determined uniquely to each device ID. When a plurality of pieces of device link profile information associated with the device ID of the delivery destination have been found, an instruction as to which piece of the plurality of pieces of device link profile information to be used may be accepted from the delivery destination or the delivery source.

Further, for example, for a print output machine which is an inkjet printer using six colors of inks, device link profile information, such as device link profile information for printing using four colors of inks in the print output machine, and device link profile information for printing using six colors of inks likewise, may be generated for each number of colors to be used for printing. In this case, in accordance with information about the number of colors to be used for printing, which information is accepted from the delivery destination in advance, device link profile information for the number of colors may be selected in accordance with the accepted information and used in the color conversion process. Alternatively, an instruction as to which piece of device link profile information to be used may be accepted from the delivery destination or the delivery source as described above.

Further, the procedure of the color conversion process maybe changed in accordance with such a difference in the number of colors. For example, two stages of color conversion processes may be performs in such a manner that the first color conversion process is performed on the assumption that four colors of inks are used, and the next conversion process proper to use of six colors of inks is performed.

In addition, the procedure of the color conversion process may be changed not only in accordance with a difference in the number of colors but also in accordance with the coloring system (category of an inkjet system, an electrophotographic system or the like) of a print output machine to be used in the delivery destination.

Further, in the description made till now, color-measuring result data registered for each device ID is used for generating device link profile information. However, for example, general data prepared in advance for each kind of print output machine specified by each device ID may be used. Alternatively, both the device link profile information generated using such general data and the device link profile information generated using real color-measuring result data may be stored in the disk unit 13 or the database 7 to thereby allow a delivery destination agency or a delivery source agency to select one to be used.

Further, the control portion 11 performs the processes in the system according to the first embodiment. Each process may be distributed to be performed. For example, a module related to each process may be provided to a server unit of another company so that the process is performed in the server unit.

Further, in the system according to the second embodiment, each process is distributed to a plurality of server groups so as to be performed thereby. Thus, the number of server units 10 in each server group can be adjusted in accordance with the condition of a processing load on the server group. However, one server unit may be designed to perform all the processes. Alternatively, server units 10 in each server group may be assigned to different organizations (for example, different companies).

Further, a server unit 10 belonging to the data check server group 2 may perform a predetermined correction process on data as well as a preflight check.

In addition, the device link profile information may include information of paper to be used in each agency, and color profile information or the like for each device, which color profile information is generated based on a predetermined image formed on the paper. Thus, processing such as color conversion can be carried out also in consideration of paper to be used in each agency.

Further, in the system according to the third embodiment, each process is distributed to a plurality of server groups so as to be performed thereby. Thus, the number of server units 10 in each server group may be adjusted in accordance with the condition of a processing load on the server group. However, one server unit may be designed to perform all the processes. Alternatively, server units 10 in each server group may be assigned to different organizations (for example, different companies).

Further, in the description made till now, one second agency is set as a delivery destination of data delivered from a first agency. However, a plurality of delivery destinations may be designated as second agencies. In this case, server units of respective server groups perform the processes for each specified second agency, and data processed correspondingly to each second agency is distributed to the second agency.

[Software Distributed to Agencies]

In order to gain access to the web server group 1 of the system, for example, the personal computer system PC of each agency may be allowed to designate a project ID, a data delivery destination and soon via a virtual printer driver setting screen (such as an output dialog of PDFTransit™). To this end, software by which the setting screen is provided and the contents of setting from each user via the setting screen are sent to each server unit 10 belonging to the web server group 1 may be installed in the personal computer PC of each agency in the form of the virtual printer driver per se or add-on software for the virtual printer driver.

What is claimed is:

1. A print service support system for supporting print service for producing prints related to data while delivering the data among a plurality of agencies, comprising:
a unit for accepting information for specifying the plurality of agencies;
a unit for generating project information as information for specifying agencies to carry out a project, the project information including at least a part of the information for specifying the plurality of agencies and remarkable machine information for specifying a given remarkable print output machine of print output machines which are available in the project to be carried out;
a selection unit for selecting at least one piece of the information for specifying the agencies, which information is included in the generated project information;
a unit for generating device link profile information for each agency specified by the information selected by the selection unit, the device link profile information including information for simulating color reproducibility of the remarkable print output machine using a print output machine to be used by the agency, and information for specifying the agency; and
a storage unit for storing the generated device link profile information;
wherein the device link profile information is used for delivering data from one of the agencies to another.

2. The print service support system according to claim 1, further comprising:
a unit for accepting sequence information for defining delivery sequence of data among the agencies specified by information included in the project information;
wherein the device link profile information is generated sequentially in the sequence defined by the sequence information, and stored by the storage unit.

3. The print service support system according to claim 1, further comprising:
a unit for acquiring information from each of the plurality of agencies, the information including information for specifying color reproducibility of one or more print output machines available by the agency, and information for specifying one of the one or more print output machines as default;
wherein the unit for generating device link profile information generates device link profile information using information for specifying color reproducibility of the print output machine specified as default, of the information for specifying color reproducibility of the one or more print output machines which information is acquired from each agency.

4. A print service support method for supporting print service for producing prints related to data while delivering the data among a plurality of agencies, comprising the steps of:
generating project information as information for specifying agencies to carry out a project, the project information including at least a part of the information for specifying the plurality of agencies and remarkable machine information for specifying a given remarkable print output machine of print output machines which are available in the project to be carried out;
selecting at least one piece of the information for specifying the agencies, which information is included in the generated project information;
generating device link profile information for each agency specified by the information selected in the selecting step, the device link profile information including information for simulating color reproducibility of the remarkable print output machine using a print output machine to be used by the agency, and information for specifying the agency; and
storing the generated device link profile information;
wherein the steps are executed by a computer system; and
the device link profile information is used for delivering data from one of the agencies to another.

5. A print service support program for realizing a processing to a computer to support print service for producing prints related to data while delivering the data among a plurality of agencies, comprising:
generating project information as information for specifying agencies to carry out a project, the project information including at least a part of the information for specifying the plurality of agencies and remarkable machine information for specifying, of print output machines available in the project to be carried out, a given remarkable print output machine;
selecting at least one piece of the information for specifying the agencies, which information is included in the generated project information;
generating device link profile information for each agency specified by the information selected in the selecting step, the device link profile information including information for simulating color reproducibility of the remarkable print output machine using a print output machine to be used by the agency, and information for specifying the agency; and
storing the generated device link profile information in a storage unit;
wherein the device link profile information is used for delivering data from one of the agencies to another.

6. A print service support system comprising:
a data acceptance server group, a data processing server group and a data delivery server group, each group including at least one server unit; and
a database generated in advance based on profile information about a device to be used by each agency, the database retaining predetermined processing parameters for data to be delivered from an agency which will be a delivery source of the data to an agency which will be a delivery destination of the data;
wherein as to data related to print service accepted from a delivery source by one server unit of the data acceptance server group, one server unit of the data processing server group acquires, from the database, the predetermined processing parameters between an agency which will be a delivery destination of the data and an agency which will perform final output of the data, and processes the data based on the acquired predetermined processing parameters; and
wherein one server unit of the data delivery server group distributes the processed data to the agency which will be a delivery destination of the data.

7. The print service support system according to claim 6;
wherein the number of server units belonging to each of the data acceptance server group, the data processing server group and the data delivery server group is determined in accordance with a load on the server units in each of the server groups.

8. The print service support system according to claim 6, further comprising:
a data check server group including at least one server unit;
wherein only when one server unit belonging to the data check server group concludes that data accepted by a server unit belonging to the data acceptance server group satisfies a predetermined check condition for an agency set as a delivery destination of the data, one server unit of the data processing server group acquires, from the database, the predetermined processing parameters between an agency which is a delivery source of the data and an agency which will be a delivery destination of the data, and processes the data based on the acquired predetermined processing parameters.

9. A print service support method using a data acceptance server group, a data processing server group and a data delivery server group, each group including at least one server unit, and a database generated in advance based on profile information about a device to be used by each agency, the database retaining predetermined processing parameters for data to be delivered from an agency which will be a delivery destination of the data to an agency which will perform final output of the data, the method comprising the steps of:
allowing one server unit of the data processing server group to acquire data related to print service accepted from a delivery source by one server unit of the data acceptance server group;
allowing the server unit acquiring the data to acquire, from the database, the predetermined processing parameters between an agency which is a delivery source of the data and an agency which will be a delivery destination of the data, and processes the data based on the acquired predetermined processing parameters; and
allowing one server unit of the data delivery server group to distribute the processed data to the agency which will be a delivery destination of the data.

10. A print service support system for supporting print service for producing prints related to data while delivering the data among a plurality of agencies, comprising:
a data acceptance server group, a preprocessing server group, a data processing server group and a data delivery server group, each group including at least one server unit;
a unit for accepting information for specifying the plurality of agencies;
a unit for generating project information as information for specifying agencies to carry out a project, the project information including at least a part of the information for specifying the plurality of agencies and remarkable machine information for specifying, of print output machines available in the project to be carried out, a given remarkable print output machine; and
a unit for generating predetermined processing parameters as to a print output machine to be used by each agency and the remarkable print output machine, and retaining the predetermined processing parameters in a database;
wherein a server unit belonging to the preprocessing server group judges whether data related to print service accepted from a delivery source by one server unit of the data acceptance server group satisfies a predetermined providing condition or not, and when the server unit concludes that the data does not satisfy the providing condition, one server unit of the data processing server group acquires, from the database, the predetermined processing parameters as to a print output machine to be used by an agency which will be a delivery destination of the data and the remarkable print output machine, and processes the data based on the acquired predetermined processing parameters;
one server unit of the data delivery server group distributes the processed data to the agency which will be a delivery destination of the data; and
wherein when the server unit of the preprocessing server group concludes that the data related to print service and accepted from the delivery source satisfies the providing condition, the data is distributed directly to the agency which will be a delivery destination.

11. The print service support system according to claim 10, wherein the number of server units belonging to each of the data acceptance server group, the preprocessing server group, the data processing server group and the data delivery server group is determined in accordance with a load on the server units in each of the server groups.

12. A print service support method for supporting print service for producing prints related to data while delivering the data among a plurality of agencies, using a data acceptance server group, a preprocessing server group, a data processing server group and a data delivery server group, each group including at least one server unit, the method comprising:
allowing one of the server groups to accept information for specifying the plurality of agencies;
allowing one of the server groups to generate project information as information for specifying agencies to carry out a project, the project information including at least a part of the information for specifying the plurality of agencies and remarkable machine information for specifying, of print output machines available in the project to be carried out, a given remarkable print output machine;
allowing one of the server groups to generate predetermined processing parameters as to a print output machine to be used by each agency and there markable print output machine, and retain the predetermined processing parameters in a database; and
allowing a server unit belonging to the preprocessing server group to judge whether data related to print service accepted from a delivery source by one server unit of the data acceptance server group satisfies a predetermined providing condition or not;
wherein when the server unit concludes that the data does not satisfy the providing condition, one server unit of the data processing server group acquires, from the database, the predetermined processing parameters as to a print output machine to be used by an agency which will be a delivery destination of the data and the remarkable print output machine, and processes the data based on the acquired predetermined processing parameters;
one server unit of the data delivery server group distributes the processed data to the agency which will be a delivery destination of the data; and
when the server unit belonging to the preprocessing server group concludes that the data satisfies the providing condition, the data related to the print service and accepted from the delivery source is distributed directly to the agency which will be a delivery destination.
